(19) United States
(12) Patent Application Publication
(10) Pub. No.: US 2024/0104611 A1
(43) Pub. Date: Mar. 28, 2024

(54) INTELLIGENT CONTENT RECOMMENDATIONS BASED ON SELECTIONS OF CURATED REVIEW RESPONSES

(71) Applicant: MICROSOFT TECHNOLOGY LICENSING, LLC, Redmond, WA (US)

(72) Inventors: Eric Warner TAYLOR, Renton, WA (US); Aaron John Mayer BUCKLEY, Mercer Island, WA (US); Jesse Dylan MERRIAM, Redmond, WA (US)

(21) Appl. No.: 17/951,068

(22) Filed: Sep. 22, 2022

(51) Int. Cl. G06Q 30/02

(52) U.S. Cl. CPC G06Q 30/0282

(57) ABSTRACT

The techniques disclosed herein provide recommendations of content based on user selections of curated review responses. A system can provide a set of curated response candidates and a related question to users providing a review of a product. The set of curated response candidates are selected based on a category that is determined by one or more factors. For example, if a user is to provide a review on a video game, the category can be based on aspects of the video game, such as visual features, game play features, etc. A user can respond to the question by selecting at least one of the curated response candidates. The system can then analyze a data structure that associates the selected response to one or more characteristics to determine characteristics that are preferred by the user. The system can then use the characteristics to recommend other content.

### BACKGROUND

There are many different types of review systems that allow users to provide feedback on content, products, and services. Some systems allow users to provide a simplistic response such as a “like” or “dislike” or a thumbs up or thumbs down. Some star rating systems allow users to provide a simplified unit of measure, such as a star rating ranging from 1 to 5. In addition, other systems allow users to provide more comprehensive feedback, which may be in the form of a free-form text response or in a free-form video response. For example, a user may provide a free-form text description of their specific experience with a video game they purchased.

Although existing systems allow users to provide reviews on products or services, there are a number of drawbacks with existing review systems. When it comes to the systems that utilize simplistic responses, such systems may not provide enough information for creators to make improvements. For example, if a person provides a “like” for a video game, this type of feedback does not provide the context regarding specific features that they liked. A creator designing the content of the game cannot readily determine if a customer liked aesthetic features, game play features, storyline features, etc. In such scenarios, it may be difficult for a product designer or service provider to make adjustments to accurately accommodate desired target markets.

Systems that allow users to provide free-form reviews can present other types of issues. Although free-form review systems can provide details that may be needed to help creators understand the context regarding specific features, these systems require the creators and system managers to review text reviews, which can be a cumbersome task given that there may be thousands or millions of reviews. Further, free-form review systems can create a wide range of privacy and content moderation problems. Since the free-form review systems allow end users to provide any description of a product or service, each review must be manually reviewed to ensure that appropriate comments are made and to ensure that a system maintains a standard of integrity and that the system maintains the privacy of all users. This manual review typically requires lots of computing resources and human resources to review vast collections of reviews to ensure that the comments do not have inappropriate text, SPAM, or comments that violate the privacy rights.

Free-form review systems can also create lots of resource issues and also have the potential of creating inaccurate feedback unless the comments are monitored appropriately. In some cases, individual products can have thousands of reviews, and when it comes to large libraries of content or other products, this can lead to thousands or millions of reviews that have to be moderated. Thus, not only do most system require lots of resources, these systems that require a manual scrubbing process do not often scale appropriately when content, products or services are sold to large customer groups. These systems also introduce the element of human error, which can lead to inaccurate review data reaching a content creator. In addition, although some systems can provide automated moderation and monitoring features, such systems cannot provide the accuracy and adaptivity that is needed to appropriately monitor shifting trends of inappropriate or inaccurate comments.

These above-described issues, and others, can be costly in terms of computational resources. Free-form review systems require users to communicate vast quantities of information to a system and computing resources are needed to present the data to allow users to understand and interpret the feedback. In addition, when it comes to a manual scrubbing process there is room for the element of human error, thus privacy issues and quality control issues can still be a problem even with solutions that are introduced in current technologies. these errors can also cause the need for duplicated efforts and the unnecessary communication and processing of lots of information.

In the end, the tasks involved with manual moderation and monitoring tasks also require large amounts of computing resources, including processing resources, storage resources, and network resources.

### SUMMARY

The techniques disclosed herein provide content recommendations based on user selections of curated review responses. A system can provide a set of curated response candidates and a related question to users providing a review of a product. The set of curated response candidates are selected based on a category that is determined by one or more factors. For example, if the system is preparing a review for a video game, the system may select one or more categories can be based on aspects of the video game, such as visual features, game play features, etc. The selection of the category can also be based on other factors pertaining to the person providing the review. This can include, but is not limited to, the user's purchase history, profile data, or review history, i.e., what did they “like” or “dislike” in prior reviews, etc. The selected set of curated response candidates and selected question are then displayed to the user. The user can then select at least one of the curated response candidates. The system can then analyze a data structure that associates the selected responses with characteristics to identify characteristics that are preferred by the user. The system can then use the identified characteristics to recommend other content to the user.

The utilization of the curated responses provides several technical advantages over other solutions. For instance, the utilization of a database that associates curated responses with characteristics, eliminates the need for content moderation of customer reviews. This eliminates or greatly mitigates the need for extensive resources that are required for maintaining privacy and proper content moderation in free-form review systems. Often, free-form responses are sorted through a community sift content moderation platform to filter out undesired customer responses.

Of course, incorporating a content moderation system adds a technical workload and technical complexity to any rating system. The curated response review system described herein avoids the need for a community sift solution since the customer responses are predetermined by the product owners.

One benefit that is part of the curated response system is the ability to leverage customer ratings data to provide personalized shopping experiences. Some systems leverage player ratings data, like likes/dislikes or star ratings, to provide curated content experiences (e.g., showing similar content to what users have “liked”). However, existing systems do not leverage canned-response rating data. The embodiments disclosed herein provide a level of ratings data and information that can be far more detailed and effective at providing personalized shopping experiences than existing review systems, without the need of crawling/parsing through free-form responses looking for key words to influence algorithms. In addition to providing recommendations for content, products, or services, the techniques can be disclosed herein can also identify content for search engines, social networks, or any other platform that provides content recommendations for users.

In some existing systems, content personalization algorithms look at a piece of content that someone has “liked”, and, based on some qualities of that content the algorithm shows other content of similar qualities. Based on a like, though, a system cannot identify specific aspects or qualities of a piece of content a user liked. For example, if a video game includes both snakes and dragons, generic “like” review systems may not be able to determine if users like dragons or snakes. However, with the curated (or “canned”) response system disclosed herein, a system can identify additional details about a piece of content a user “liked”. For example, if a system provides users with the ability to select canned responses related to their experience around a piece of content's single/multiplayer experience, the system can identify whether the user prefers single or multiplayer experiences. Additionally, if a system provides canned responses related to the piece of content's difficulty, then a system can determine if the user prefers easy or difficult game content. With the data from those two prompts, a system can determine that certain users prefer difficult, multiplayer experiences. Once the system determines such characteristics that are preferred by a user, the system can identify and recommend similar content. The canned response data has the power to provide much more powerful data than traditional “like” or free-form methodologies.

For illustrative purposes, consider a scenario where a system provides questions for a review of a video game that includes outdoor scenery. For a review of this type of content, the system may select a category that is focused on visualizations. The visualizations category can be associated with a predetermined question that directs the user to specific aspects of the content, e.g., “What did you like about the scenery?” The selected category can also be associated with a number of curated response candidates, such as “beautiful city skylines,” “mountain views were terrific,” “I prefer games with indoor scenes,” etc. Each of the curated response candidates can be associate with specific characteristics. For example, the first response candidate can be associated with a specific characteristic such as “user prefers games with city environments,” the second response candidate can be associated with another characteristic such as “user prefers games in wilderness environments,” and the last response candidate can be associated with a characteristic such as “user prefers games with indoor environments.” Thus, when the user selects any one of the response candidates, the system can associate that user as having a preference for a particular characteristic. The system can then use that characteristic of the user to identify and recommend other content, such as other games, artwork, or other products having similar characteristics.

In some embodiments, a system can determine specific user preferences utilizing specific questions with short answers. For example, if a set of curated response candidates includes “yes” and “no” answers to specific questions regarding a particular product or a particular product feature, the system can make a determination with respect to a persons' specific preferences. A set of questions can start with general questions, e.g., did you like the video game, and subsequent questions can be regarding specific features such as avatars, scenery, etc. Depending on a reviewer response to each question, the system can determine specific preferences. For example, a set of questions with short yes or no answers can cause a system to generate an output defining specific user preferences, e.g., does a person prefer snakes or dragons in video games. The system can use this type of data to recommend other content with the specific features that are preferred by a person. The system can also generate data that includes the reviewers on an inclusion list or an exclusion list for products or services. A system can then utilize an inclusion list to cause a display of a recommendation for particular content to appear more often to a person who performed a review. In addition, a system can utilize an exclusion list to reduce a frequency of a display, or eliminate a display, of a recommendation for particular content.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for providing recommendations of content based on user selections of curated review responses.

FIG. 2A is a first section of an example review form generated by one or more selected categories.

FIG. 2B is a second section of an example review form generated by one or more selected categories.

FIG. 3A shows a first section of metadata that can be generated as users interact with a review form.

FIG. 3B shows a second section of metadata that can be generated as users interact with a review form.

FIG. 4 shows an example of a user interface displaying output data showing results generated from completed review forms across multiple users.

FIG. 5 an example of a user interface displaying a review form comprising questions and user selections of response candidates.

FIG. 6 shows an example of a user interface displaying output data showing results generated from completed review forms comprising selected questions and user selections of response candidates.

FIG. 7 is a flow diagram showing aspects of a routine for providing recommendations of content based on user selections of curated review responses.

FIG. 8 is a computer architecture diagram illustrating an illustrative computer hardware and software architecture for a computing system capable of implementing aspects of the techniques and technologies presented herein.

### DETAILED DESCRIPTION

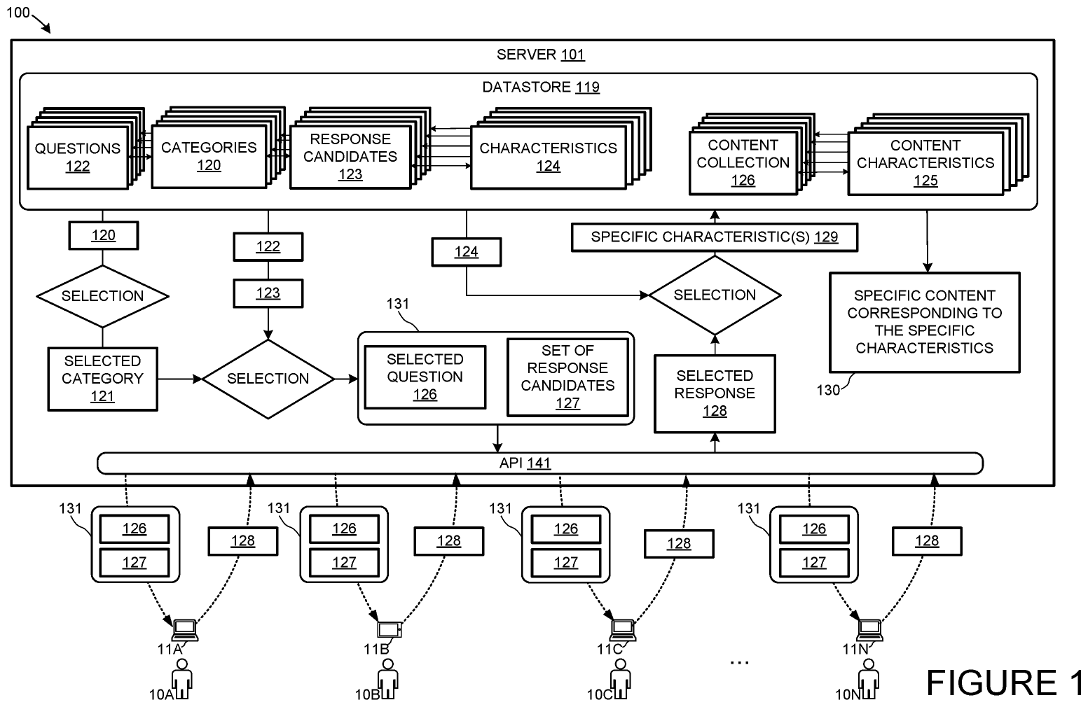

FIG. 1 illustrates a system 100 that provide recommendations of content based on user selections of curated review responses. In this example, the system allows a number of users 10 associated with individual computing devices 11 to interact with a server 101 configured to provide reviews for content, products or services. The server can also be configured to provide recommendations for content. In this illustrative embodiment, the server can include a datastore 119 having a number of predetermined questions 122 that are associated with a number of curated response candidates 123. For example, the datastore 119 associates a specific question such as “What features did you like most about the game?” with a number of associated curated response candidates, such as “I like the complex nature of the maps,” “I like the mountain scenery,” “I like the in-app purchase items,” “I like the avatar designs,” “I like the multiplayer feature,” etc. The datastore 119 also associates the curated response candidates with one or more characteristics 124. For example, the datastore can respectively associate the above-described response candidates with one or more characteristics such as, complex maps, mountain scenery, in-app purchase items, avatar designs, multiplayer, etc. The datastore 119 also associates individual categories 120 with individual questions 122 and individual sets of curated response candidates 123. For example, a “general” category can be associated with the above-described questions and response candidates. In another example, a “visualization” category may be associated with a question such as “what did you like most about the scenery?” and a number of curated response candidates such as “the avatar uniforms,” “the virtual command center design,” “the outdoor scenery,” etc. As the scribed in more detail below, these associations allow the system to select questions and sets of curated response candidates. In addition, these associations allow the system to identify characteristics or user preferences based on a user selection of the curated response candidates.

The datastore 119 may also associate individual pieces of content of a content collection 128 with content characteristics 125. For instance, a database may have a list of a number of different video games, and individual video games may be associated with individual content characteristics 124, such as, multiplayer, single player, difficult, ease etc. These associations allow the system to select pieces of content based on identified characteristics or user preferences. For illustrative purposes, pieces of content are also referred to herein as “content units” or “units of content.” In one example, a unit of content, such as a stand-alone video game program, can be selected based on an identified characteristic, e.g., difficult games, easy games, multi-player games, single-player games, etc.

Although this example illustrates one datastore having different sets of associated data, it can be appreciated that the techniques disclosed herein can be implemented using a number of different datastores having different data set groupings. Such configurations can include a number of curated response candidates 123, and each individual curated response candidates 123 can correspond to individual content characteristics 124.

In some embodiments, a review for a particular item can be generated in response to the selection of one or more categories. The use of the selected categories allows the system to guide questions and answers to specific topics, e.g., visuals, game type, etc. In some instances, a single category or multiple categories can be selected for a review of a particular item. In instances, different categories can be selected for different recipients, e.g., if the category is based on contextual data defining activity of the recipients.

The selected categories can be based on a number of factors. For instance, the system may select a category based on aspects of the item that is being reviewed. A category be based on any combination of aspects of an item, such as, but not limited to, a physical characteristic, a functional characteristic, a level of adaptability, a level of difficulty, etc. The category can also be based on an item type, such as a video game, artwork, etc. More specific characteristics can also be involved such as a video game type, multiplayer, single player, ability to utilize purchases, and ability to utilize skins, etc.

For illustrative purposes, consider an example where the datastore has a collection of categories 120, wherein individual categories include: visualizations, gameplay, storyline, in-app purchase items, etc. In this example, each category is also associated with individual questions and specific sets of curated response candidates 123. If a review is about a particular item, such as a plug-in that provides visuals for a video game, the system may select the “visualizations” category.

Each category can be associated with descriptive metadata, such as keywords or any other descriptive text. For instance, the visualizations category can be associated with keywords such as map packs, scenery, mountain view, etc. When a review is to be completed for a particular item, e.g., a video game, the system can analyze any attribute associated with the video game with the descriptive metadata of each category. Examples of attributes for a particular item, e.g., a video game, can include a text description of the game or keywords. For example, video game attributes can be derived from a product description of a video game. Descriptions can be lengthly, thus, keywords can be extracted from a text description to generate a list of attributes for an item to be reviewed. For example, if a label of a game describes a game as being a family-oriented, first-person adventure game, the system may derive a list of attributes from that description for analysis. If one or more video game attributes has a threshold match with the metadata of a particular category, that category is selected for use in selecting curated response candidates.

In another example, the selection of a category can be based on contextual data defining user activity, e.g., purchase history, profile data, review history, etc. This way, the system can use the results of a simplistic review, e.g., what did they “like” about other products, or other activity, to select a category, wherein the selection of the category is used for the purposes of identifying select curated response candidates. For instance, if a recipient of a review has a threshold number of “likes” for products that are related to the item being reviewed, that type of contextual data can be utilized to influence the selection of the category. Consider an example where an item being reviewed is a video game that can utilize map packs, and the recipient of the review has a history of liking a certain type of map packs, the system may select a specific category the focuses on map packs instead of solely selecting a category on the video games that utilize map packs. this allows the system to direct the review to include more specific questions and curated response candidates regarding map packs.

Once the system determines a selected category 121, the system can use the selected category 121 to a selected question 126 from the collection of questions 122 and a set of curated response candidates 127 from a collection of curated response candidates 123. This selection can be based on the associations that are made between the categories 120 and individual of the collection of questions 122, and the associations that are made between the categories 120 and individual of the collection of curated response candidates 123. The selected question 126 and the set of response candidates 127 can be packaged in a review form 131 and the review form 131 can be communicated to the client devices 11. The communication of the review form 131 can be facilitated by a number of different types of interfaces, including an application programming interface 141.

When the recipients 10 of each respective client device 11 interact with the review form 131 and select individual responses from the set of response candidates 127, the system communicates the selected response(s) 128 from the client devices 11 to the server 101. The server 101 can then process the input data identifying the selected response(s) 128 from the one or more computing devices 11. In response to receiving the selected response(s) 128, the server 101 can select specific characteristics 129 that corresponds to the selected response 128. In some embodiments, the selection of the of the specific characteristics 129 is based on an analysis of one or more datastores 119 that associates individual curated response candidates with corresponding the individual content characteristics 124. The system may identify one or more specific characteristics 129, e.g., difficult, multiplayer games, by identifying associations between the response candidates and the characteristics. For instance, a particular response candidate can be associated with characteristics such as difficult games or multiplayer games. In this example, the one or more selected response(s) 128 are associated with individual characteristics of the collection of characteristics 124, and the individual characteristics are selected as the specific characteristics 129 that are now associated with a particular recipient of the review form.

The server uses the specific characteristics 129, e.g., difficult, multiplayer games, to identify specific content 130 from individual units of content 130 from a data structure defining a content collection 126. The specific content 130 is identified from the individual units of content 130 by analyzing one or more datastores 119 that associates the individual units of content with corresponding content characteristics 125. For illustrative purposes, the individual units of content can include items such as a video game, a map pack, visualization data, etc. The specific content 130 includes any unit of content that has a corresponding content characteristic that matches the specific characteristics 129 according to one or more criteria. The one or more criteria can include various levels of text matching, which can include exact match, matching within the threshold level, etc. The system can also use various machine learning techniques to identify a match between a specific characteristic provided in a response to a content characteristic. In some embodiments, the specific content 130 is selected from the collection of content 126 based on an identification of a unit of content having at least one content characteristic 125 that aligns with the specific characteristics 129.

The server can also generate output data identifying the specific content 130 having the specific characteristics 129 that are identified in the selected response 128 of the set of curated response candidates 127. The output data can be in the form of a search result, recommendation on a website, or a recommendation for a designer to make modifications to a product.

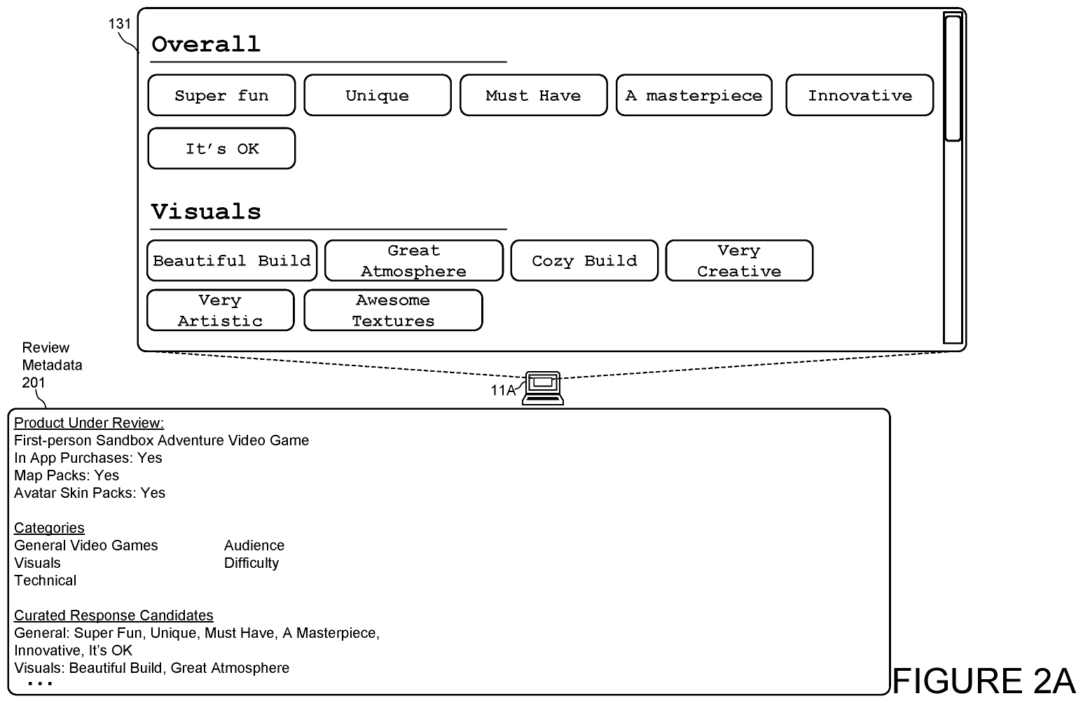

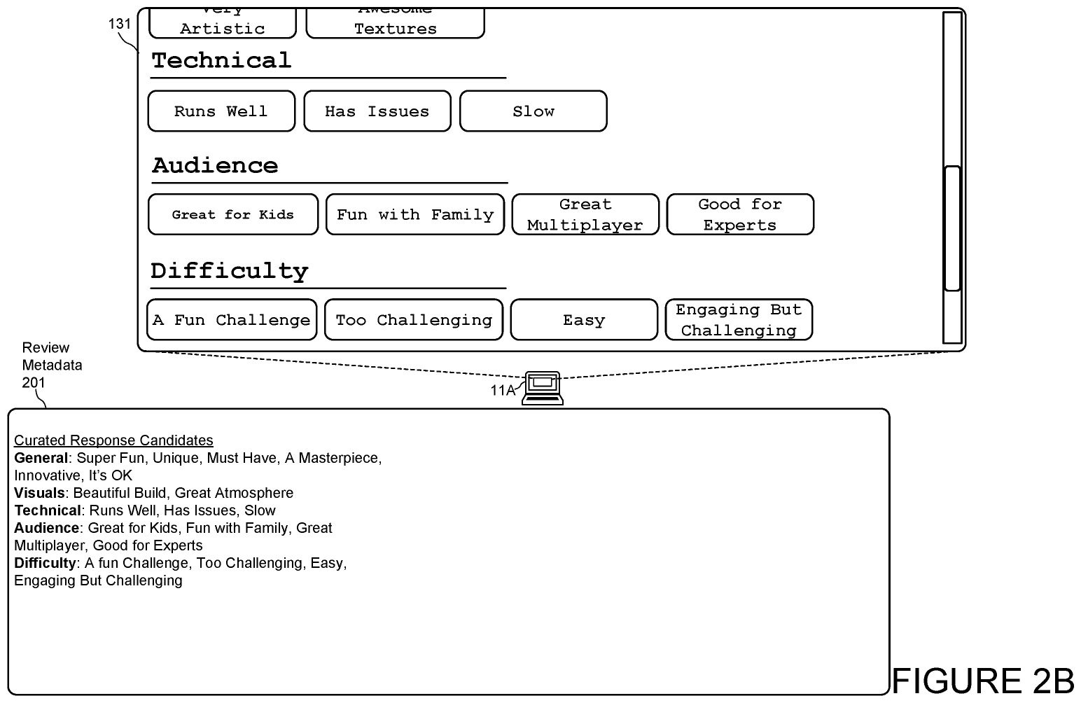

FIGS. 2A and 2B illustrate an example review form 131 that is generated from the selected curated response candidates. The example shows an embodiment where multiple categories are used to select sets of curated response candidates. This particular example does not include the selection of questions corresponding to the curated response candidates. This example also shows an embodiment where categories are selected based on aspects of the content being reviewed. This allows the system to provide different questions to gain specific details of a person's preferences.

In this illustrative example, the system generates review metadata 201 to maintain the state of each stage of the review process. For example, as shown in FIG. 2A, the review metadata can include specifications of the item that is being reviewed. In this example, the item is a first-person sandbox adventure video game. Other attributes of the item under review can also be stored for analysis, e.g., the game accepts in-app purchases, map packs, and avatar skin packs. This information can be utilized to select categories for the review form. In some embodiments, the categories can be selected based on keywords that are stored in association with each category. When a keyword stored in association with a particular category has a threshold match with the item attributes, the system can select that particular category. A threshold match can be based on a confidence level of a keyword match or based on any suitable machine learning techniques for identifying matching text.

In this example, given the item attributes, the selected categories include video games, visuals, technical, audience, and difficulty. The video games category is selected given that the item is a first-person video game. The visuals category is selected given that the item utilizes map packs and skin packs. The other categories can be based on the fact that the item is a video game, or that the item involves software.

The system can also store the sets of response candidates in the metadata. In this example, each category list a number of response candidates that are selected for the review form. FIG. 2A shows the response candidates for the first two categories and FIG. 2B shows the response candidates for the other selected categories. The system can then use the metadata to generate the review form 131 and send the review form to the client device 11A for display to a user, e.g., the recipient to complete the review.

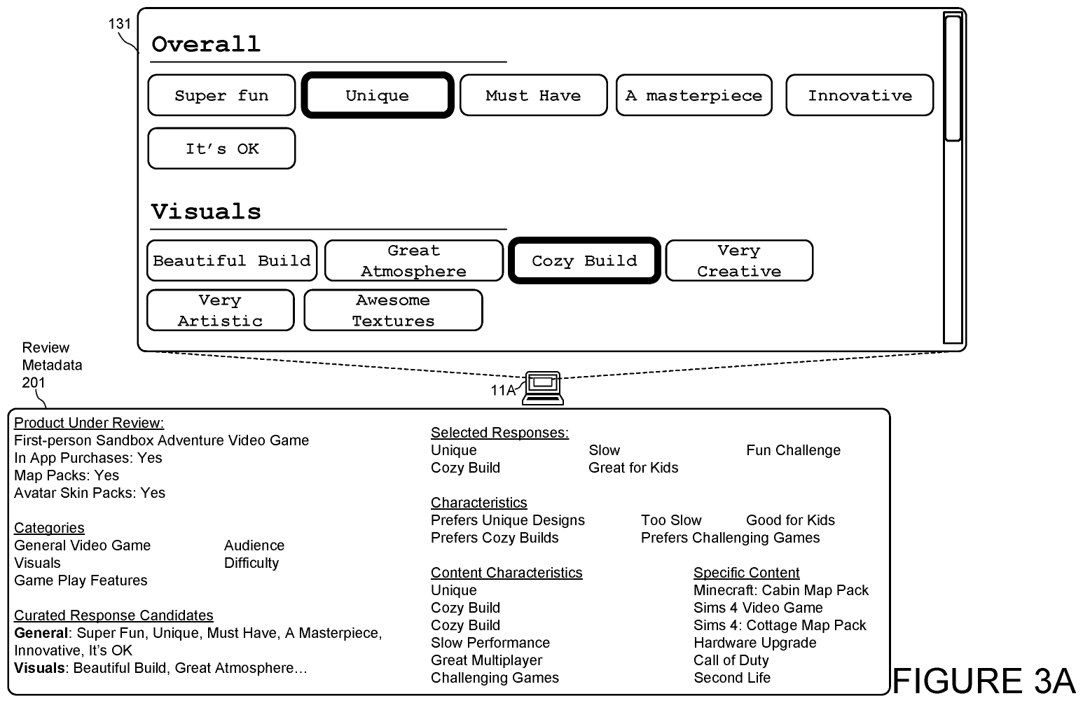

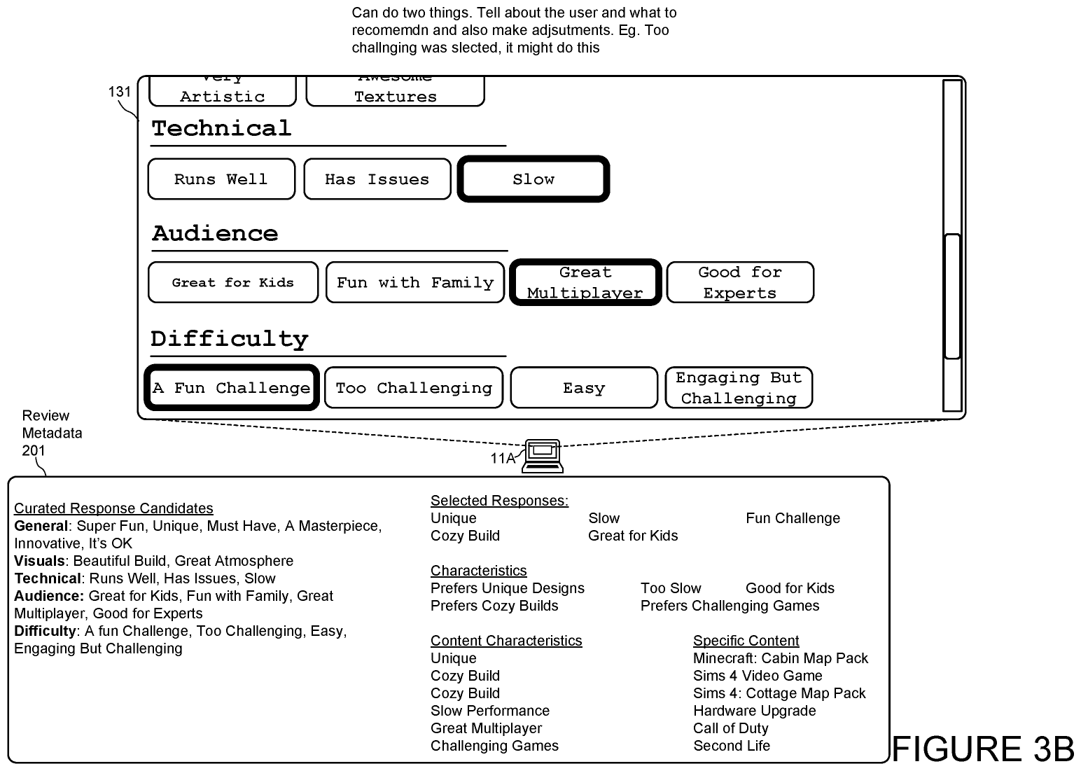

FIG. 3A and FIG. 3B illustrate how the metadata can be updated once the user responds to the review form. In this example, as the user selects the individual response candidates, the system can record those response selections. In this example, as shown in FIG. 3A, a user input indicates a selection of the “Unique” and “Cozy Build” response candidates. As shown in FIG. 3B, the user input indicates a selection of the “Slow,” “Great Multiplayer” and “A Fun Challenge,” response candidates. Based on these selections, the system determines any records characteristics associated with the user's selections. In this case, the characteristics can come from a database that associates each response candidate with one or more characteristics. As shown, the determined characteristics are stored in the metadata.

Next, the system can identify content characteristics that have a threshold match with the determined characteristics and use that match to identify specific content. For example, if the datastore stores a content characteristic such as “Unique,” and that content characteristic is associated with a specific Minecraft map pack, the system will generate an output recommending that specific Minecraft map pack. Similarly, the other characteristics determined from the user interaction with the review form can be used to identify content characteristics, and then use those content characteristics to identify other specific content such as Sims games, Sims map packs or other video games. In this example, the user input indicating a selection of a “Slow” curated response candidate enables the system to identify a “Too Slow” characteristic, which is in turn, used to identify a “Slow Performance” content characteristic. This type of content characteristic can then be used to provide an instruction, e.g., the system can recommend a hardware upgrade.

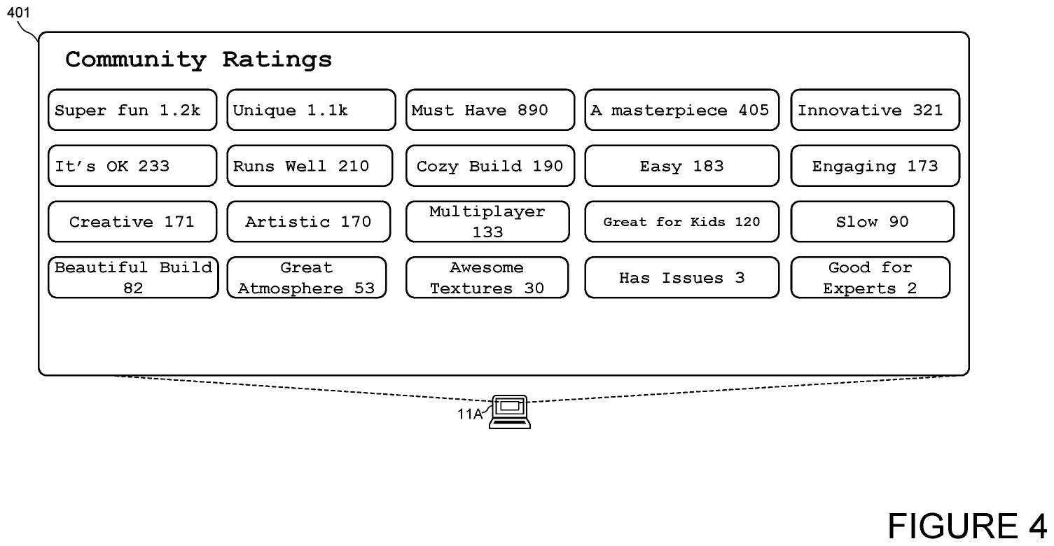

FIG. 4 illustrates an example user interface that provides a broad overview of all of the completed review forms. In this example, after a number of review forms have been completed, the system output shows that the “Super fun” response candidate has been selected 1.2K times, that the “Unique” response candidate has been selected 1.1 K times, etc. By aggregating the responses for each review form, the system can readily provide a broad perspective all of the reviews completed by different users without requiring a manual review of all of the completed review forms.

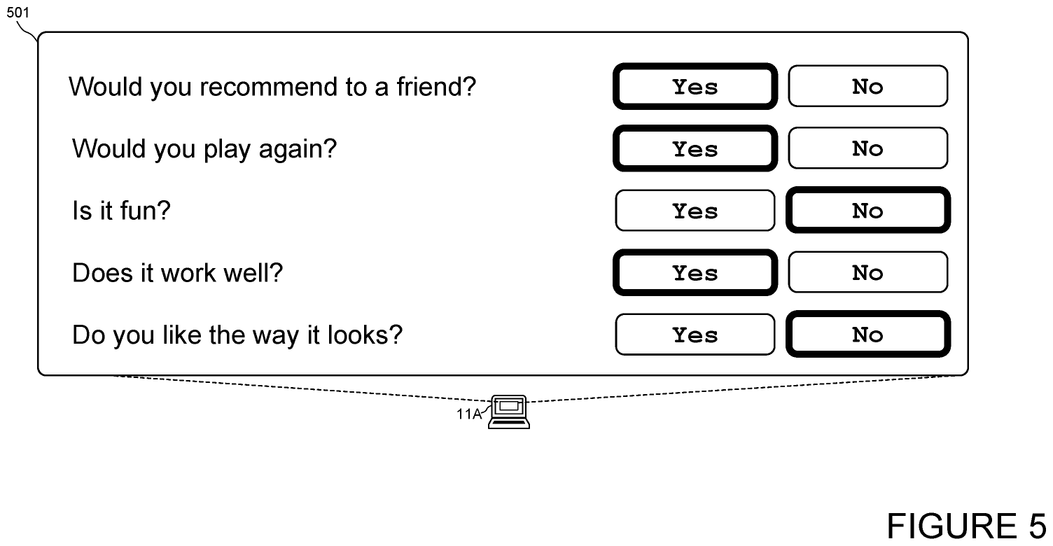

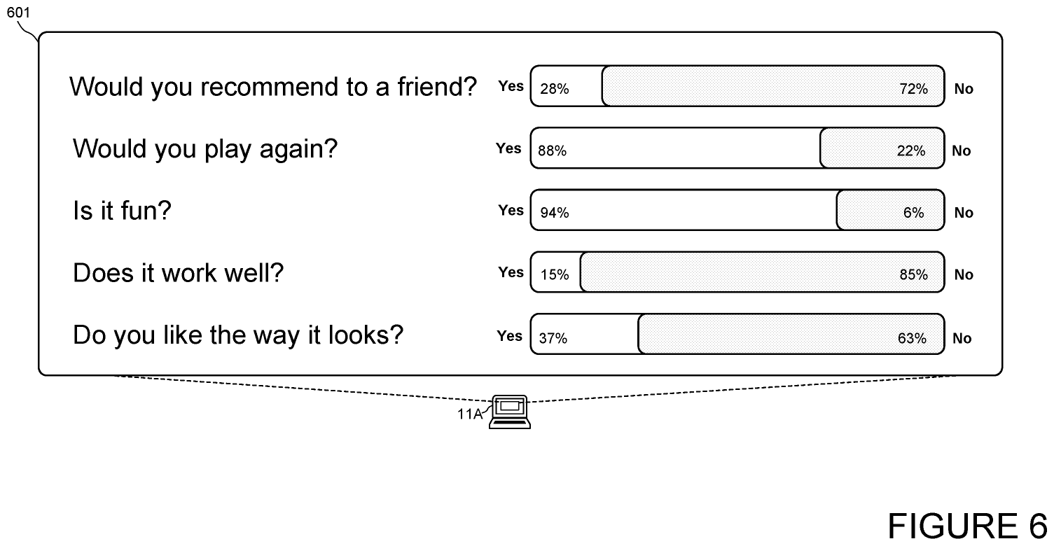

FIG. 5 illustrates another example of a review form 501 that comprises a series of selected questions and simplified “yes” and “no” curated response candidates. In this example, the system can generate a series of questions and answers, as shown. When the form is completed, as shown in FIG. 6, the system can generate a scoring system that shows all of the answers for different users.

By the use of the curated response candidates, particular points of feedback can be correlated across different users. That way, one particular point of feedback can be selected by multiple users and that particular feedback can be correlated and scored such that the system can identify users having like preferences. This is advantageous over existing systems that are freeform text because freeform text can't really correlate automatically. If a manual process is used to scrub a freeform review, it can take a person with a particular mindset to actually correlate all of those and it still may not be accurate because it's based on judgment and a subjective view. Moreover, existing systems that require a manual review does not scale. However, the techniques disclosed herein makes no mistake that when there is a number of people who are satisfied with visualizations in a particular way, those answers can be correlated to really show a group of people that have a preference which can also allow people to be to show a level of interest for a particular aspects of content, e.g., that someone likes a storyline or someone likes the aesthetic features.

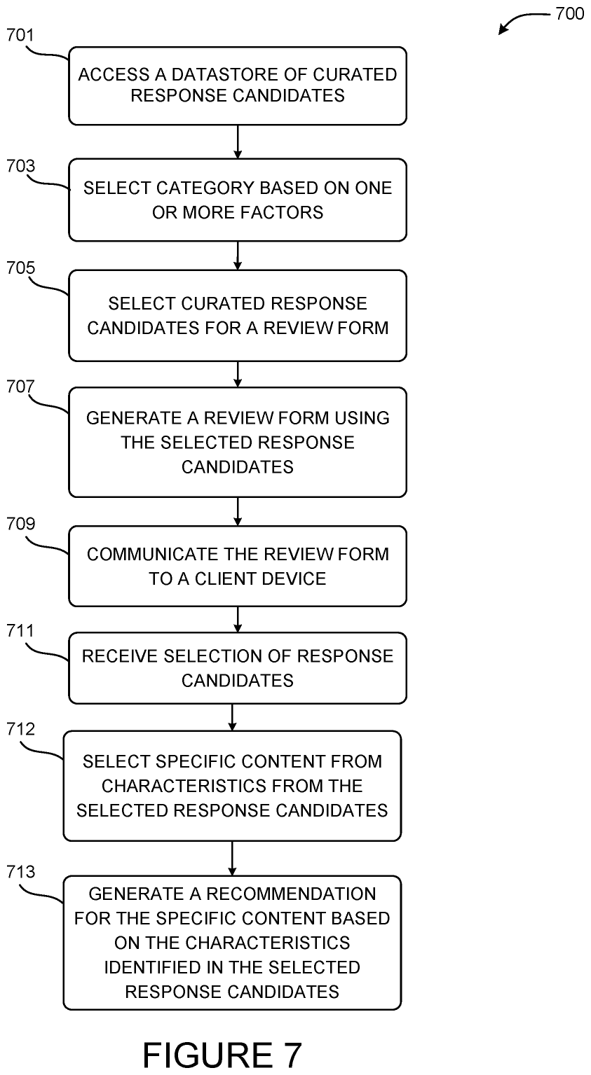

Turning now to FIG. 7, aspects of a routine 700 for providing intelligent recommendations of specific content based on selections of curated response candidates are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 700 are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor of another remote computer or a local circuit. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

With reference to FIG. 7, the routine 700 can begin at operation 701, where the system accesses one or more datastores 119 comprising a plurality of curated response candidates 123. In the datastore, the individual curated response candidates 122 correspond to individual characteristics 124. For example, the individual characteristics 124 can include characteristics like multiplayer, single player, easy games, difficult games, etc.

At operation 703, the system can select one or more categories allows the system to guide questions and answers to specific topics, e.g., visuals, game type, etc. The selected category can be based on purchase history, profile data, review history, e.g., what did they “like” before, etc. The routine can include operations for selecting a category 121 that is associated with a specific question 126 of a collection of questions 122 and a set of curated response candidates 127 of a collection of curated response candidates 123.

The selection can also be based on other contextual data. For instance, if the review is to be completed by a person who has a threshold number of likes or positive reviews for a product related to a particular topic, such as video games, the selection of the topic can be based on the that type of user activity. In another example, if the review is to be completed by a person who has a threshold number of purchases for a product related to a particular topic, the selection of the topic can be based on the that type of user activity. This enables the system to utilize other reviews which may include likes or even text responses to select a category that is used to select curated response candidates. This enables the current system to leverage other reviews, regardless of the level of detail that is involved in those prior reviews, to select appropriate questions and/or appropriate response candidates for a content review.

In one example, a video game category is selected if the item being reviewed is a video game. In such an embodiment, the selected category can be based on an analysis of attributes of the item that is a subject of a review form. An attribute can be one or more keywords describing the item. When an attribute of the item has a threshold match with one or more keywords associated with a particular category, the system can select that particular category. For illustrative purposes, a threshold match can include any type of scoring technique that comparison matches keywords not meet one or more criteria. This can include exact matching, pseudo matching or any other AI-based technology that can determine if to or more words are related.

For embodiments where the system selects a category based on a person's previous review list, e.g., if a person provided “likes” for a similar product, a system can select a category based on an analysis of a number of reviews provided by a person associated with an item that is a subject of a review form comprising the set of curated response candidates. When an attribute of other items provided in historical reviews provided by the person, e.g., “likes” they provided on other items, has a threshold match with one or more keywords associated with a particular category, that particular category can be selected. The particular category may also be selected when the previous reviews exceed one or more thresholds. A category can also be selected based on a number of purchases of related products, comments on social media of related products, or a number of preferences in a user's profile.

Next, in operation 705, the system can select curated response candidates and/or related questions to generate a review form. The selected curated response candidates can be based on an association between the response candidates and the selected category. In addition, the selected questions can also be selected based on an association between the questions and the selected category.

At operation 707, the system can generate a review form comprising the selected set of response candidates. In some configurations, the review form can include the selected set of response candidates without including related questions. In other embodiments, the review form can include these selected set of response candidates with a selected set of related questions.

Next, at operation 709, the system can cause the communication of the specific question 126 and the set of curated response candidates 127 to one or more computing devices 11. The computing devices can be associated with a user that is selected to complete the review form.

At operation 711, the system can receive input data identifying a selected response 128 from the one or more computing devices 11. The selected response 128 includes at least one curated response candidate 127 from the set of curated response candidates 127. As shown in the example of FIG. 2A, a review form can include a number of curated response candidates, and a user selection of a subset of those curated response candidates can be sent back to the server as selected responses.

At operation 712, the system can then select specific content based on specific characteristics that are identified in the user input. In some embodiments the system can identify specific characteristics 129 that correspond to the selected response 128. The selection of the of the specific characteristics 129 is based on an analysis of the one or more datastores 119 that associates individual curated response candidates 123 that correspond to the individual characteristics 124. For example, if a user selects one of the response candidates that focuses on multiplayer video games, the system may determine that the user has a characteristic, e.g., that the user is interested in video games. This allows the system to also readily determined and tabulate the number of specific characteristics of a user. For instance, if a response candidate or a set of response candidates is specific, e.g., a person likes difficult, first-person, games with complex maps, this system can readily identify those specific characteristics. this enables systems to provide very specific and targeted recommendations for content that the user might be interested in.

The specific content can be selected based on the specific characteristics that are related to the selected responses. In some configurations, specific content can be related to content characteristics. For example, a book may have content characteristics such as, adventurous, suspenseful, educational, etc. The system may identify the book as specific content if the content characteristics have an alignment with the characteristics identified in the selected response candidates. Thus, If a user selects a response candidate that indicates the user is interested in adventurous books, that particular piece of content can be selected for a recommendation.

In one example, the system can select specific content 130 from a collection of content 126. The specific content 130 is selected based on an analysis of the one or more datastores 119 that associates individual units of content with corresponding content characteristics 125, wherein the specific content 130 is selected from the collection of content 126 based on an identification of a unit of content having at least one content characteristic 125 that has a threshold match with the specific characteristics 129 that is identified in the selected response 128 from the set of curated response candidates 127.

At operation 713, the system can generate output data identifying the specific content 130 having the specific characteristics 129 that are identified in the selected response 128 from the set of curated response candidates 127. The output can be in the form of a purchase recommendation. In addition to providing recommendations for content, products, or services, the techniques can be disclosed herein can also provide recommendations for content for search engines, social networks, or any other platform that provides content recommendations for users.

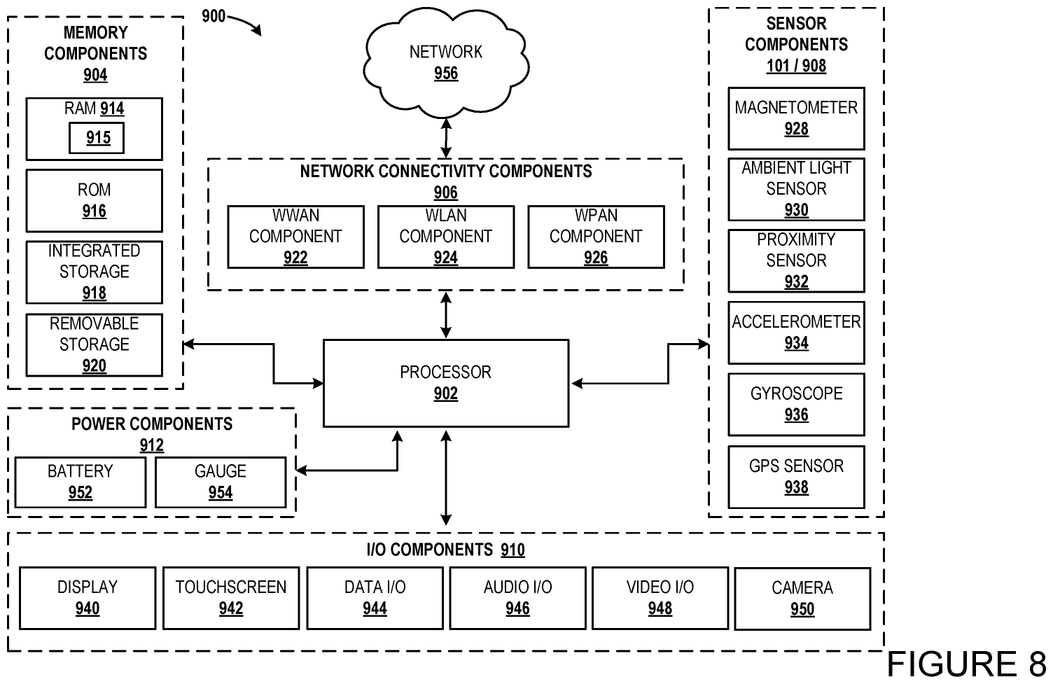

Turning now to FIG. 8, an illustrative computing device architecture 900 for a computing device that is capable of executing various software components described herein. The computing device can be a head-mounted display unit, which is also referred to herein as a headset. The computing device architecture 900 is applicable to computing devices that facilitate mobile computing due, in part, to form factor, wireless connectivity, and/or battery-powered operation. The computing device architecture 900 can be the architecture of the device 100 of FIG. 1. In some configurations, the computing devices include, but are not limited to, a near-to-eye display device, e.g., glasses or a head mounted display unit. The computing device architecture 900 can also apply to any other device that may use or implement parts of the present disclosure, including, but not limited to, mobile telephones, tablet devices, slate devices, portable video game devices, and the like. Moreover, aspects of the computing device architecture 900 may be applicable to traditional desktop computers, portable computers (e.g., laptops, notebooks, ultra-portables, and netbooks), server computers, and other computer systems, such as those described herein. For example, the single touch and multi-touch aspects disclosed herein below may be applied to desktop computers that utilize a touchscreen or some other touch-enabled device, such as a touch-enabled track pad or touch-enabled mouse.

The computing device architecture 900 illustrated in FIG. 8 includes a processor 902, memory components 904, network connectivity components 906, sensor components 908, input/output components 912, and power components 912. In the illustrated configuration, the processor 902 is in communication with the memory components 904, the network connectivity components 906, the sensor components 908, the input/output (“I/O”) components 910, and the power components 912. Although no connections are shown between the individuals components illustrated in FIG. 8, the components can interact to carry out device functions. In some configurations, the components are arranged so as to communicate via one or more busses (represented by one or more lines between the components).

The memory components 904 is connected to the CPU 902 through a mass storage controller (not shown) and a bus. The memory components 904 and its associated computer-readable media provide non-volatile storage for the computer architecture 900. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, the computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 900. For purposes the claims, the phrase “computer storage medium,” “computer-readable storage medium,” “computer-readable storage device,” “non-transitory computer storage media” and variations thereof, does not include waves, signals, and/or other transitory and/or intangible communication media, per se. A storage device can include any type of solid state drive, optical drive, or a rotating media drive.

The processor 902 includes a central processing unit (“CPU”) configured to process data, execute computer-executable instructions of one or more application programs, and communicate with other components of the computing device architecture 900 in order to perform various functionality described herein. The processor 902 may be utilized to execute aspects of the software components presented herein and, particularly, those that utilize, at least in part, a touch-enabled input.

In some configurations, the processor 902 includes a graphics processing unit (“GPU”) configured to accelerate operations performed by the CPU, including, but not limited to, operations performed by executing general-purpose scientific and/or engineering computing applications, as well as graphics-intensive computing applications such as high-resolution video (e.g., 720P, 1030P, and higher resolution), video games, three-dimensional (“3D”) modeling applications, and the like. In some configurations, the processor 902 is configured to communicate with a discrete GPU (not shown). In any case, the CPU and GPU may be configured in accordance with a co-processing CPU/GPU computing model, wherein the sequential part of an application executes on the CPU and the computationally intensive part is accelerated by the GPU.

In some configurations, the processor 902 is, or is included in, a system-on-chip (“SoC”) along with one or more of the other components described herein below. For example, the SoC may include the processor 902, a GPU, one or more of the network connectivity components 906, and one or more of the sensor components 908. In some configurations, the processor 902 is fabricated, in part, utilizing a package-on-package (“PoP”) integrated circuit packaging technique. The processor 902 may be a single core or multi-core processor.

The processor 902 may be created in accordance with an ARM architecture, available for license from ARM HOLDINGS of Cambridge, United Kingdom. Alternatively, the processor 902 may be created in accordance with an x86 architecture, such as is available from INTEL CORPORATION of Mountain View, California and others. In some configurations, the processor 902 is a SNAPDRAGON SoC, available from QUALCOMM of San Diego, California, a TEGRA SoC, available from NVIDIA of Santa Clara, California, a HUMMINGBIRD SoC, available from SAMSUNG of Seoul, South Korea, an Open Multimedia Application Platform (“OMAP”) SoC, available from TEXAS INSTRUMENTS of Dallas, Texas, a customized version of any of the above SoCs, or a proprietary SoC.

The memory components 904 include random access memory (“RAM”) 914, read-only memory (“ROM”) 916, an integrated storage memory (“integrated storage”) 918, or a removable storage memory (“removable storage”) 920. In some configurations, the RAM 914 or a portion thereof, the ROM 916 or a portion thereof, and/or some combination the RAM 914 and the ROM 916 is integrated in the processor 902. In some configurations, the ROM 916 is configured to store a firmware, an operating system or a portion thereof (e.g., operating system kernel), and/or a bootloader to load an operating system kernel from the integrated storage 918 and/or the removable storage 920. The RAM or any other component can also store the device module 915 or other software modules for causing execution of the operations described herein.

The integrated storage 918 can include a solid-state memory, a hard disk, or a combination of solid-state memory and a hard disk. The integrated storage 918 may be soldered or otherwise connected to a logic board upon which the processor 902 and other components described herein also may be connected. As such, the integrated storage 918 is integrated in the computing device. The integrated storage 918 is configured to store an operating system or portions thereof, application programs, data, and other software components described herein.

The removable storage 920 can include a solid-state memory, a hard disk, or a combination of solid-state memory and a hard disk. In some configurations, the removable storage 920 is provided in lieu of the integrated storage 918. In other configurations, the removable storage 920 is provided as additional optional storage. In some configurations, the removable storage 920 is logically combined with the integrated storage 918 such that the total available storage is made available as a total combined storage capacity. In some configurations, the total combined capacity of the integrated storage 918 and the removable storage 920 is shown to a user instead of separate storage capacities for the integrated storage 918 and the removable storage 920.

The removable storage 920 is configured to be inserted into a removable storage memory slot (not shown) or other mechanism by which the removable storage 920 is inserted and secured to facilitate a connection over which the removable storage 920 can communicate with other components of the computing device, such as the processor 902. The removable storage 920 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 904 can store an operating system. According to various configurations, the operating system includes, but is not limited to WINDOWS MOBILE OS from Microsoft Corporation of Redmond, Washington, WINDOWS PHONE OS from Microsoft Corporation, WINDOWS from Microsoft Corporation, BLACKBERRY OS from Research In Motion Limited of Waterloo, Ontario, Canada, IOS from Apple Inc. of Cupertino, California, and ANDROID OS from Google Inc. of Mountain View, California. Other operating systems are contemplated.

The network connectivity components 906 include a wireless wide area network component (“WWAN component”) 922, a wireless local area network component (“WLAN component”) 924, and a wireless personal area network component (“WPAN component”) 926. The network connectivity components 906 facilitate communications to and from the network 956 or another network, which may be a WWAN, a WLAN, or a WPAN. Although only the network 956 is illustrated, the network connectivity components 906 may facilitate simultaneous communication with multiple networks. For example, the network connectivity components 906 may facilitate simultaneous communications with multiple networks via one or more of a WWAN, a WLAN, or a WPAN.

The network 956 may be or may include a WWAN, such as a mobile telecommunications network utilizing one or more mobile telecommunications technologies to provide voice and/or data services to a computing device utilizing the computing device architecture 900 via the WWAN component 922. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 956 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 956 may be configured to provide voice and/or data communications with any combination of the above technologies. The network 956 may be configured to or adapted to provide voice and/or data communications in accordance with future generation technologies.

In some configurations, the WWAN component 922 is configured to provide dual-multi-mode connectivity to the network 956. For example, the WWAN component 922 may be configured to provide connectivity to the network 956, wherein the network 956 provides service via GSM and UMTS technologies, or via some other combination of technologies. Alternatively, multiple WWAN components 922 may be utilized to perform such functionality, and/or provide additional functionality to support other non-compatible technologies (i.e., incapable of being supported by a single WWAN component). The WWAN component 922 may facilitate similar connectivity to multiple networks (e.g., a UMTS network and an LTE network).

The network 956 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 924 is configured to connect to the network 956 via the WI-FI access points. Such connections may be secured via various encryption technologies including, but not limited, WI-FI Protected Access (“WPA”), WPA2, Wired Equivalent Privacy (“WEP”), and the like.

The network 956 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 926 is configured to facilitate communications with other devices, such as peripherals, computers, or other computing devices via the WPAN.

The sensor components 908 include a magnetometer 928, an ambient light sensor 930, a proximity sensor 932, an accelerometer 934, a gyroscope 936, and a Global Positioning System sensor (“GPS sensor”) 938. It is contemplated that other sensors, such as, but not limited to, temperature sensors or shock detection sensors, also may be incorporated in the computing device architecture 900.

The magnetometer 928 is configured to measure the strength and direction of a magnetic field. In some configurations the magnetometer 928 provides measurements to a compass application program stored within one of the memory components 904 in order to provide a user with accurate directions in a frame of reference including the cardinal directions, north, south, east, and west. Similar measurements may be provided to a navigation application program that includes a compass component. Other uses of measurements obtained by the magnetometer 928 are contemplated.

The ambient light sensor 930 is configured to measure ambient light. In some configurations, the ambient light sensor 930 provides measurements to an application program stored within one of the memory components 904 in order to automatically adjust the brightness of a display (described below) to compensate for low-light and high-light environments. Other uses of measurements obtained by the ambient light sensor 930 are contemplated.

The proximity sensor 932 is configured to detect the presence of an object in proximity to the computing device without direct contact. In some configurations, the proximity sensor 932 detects the presence of a user's body (e.g., the user's face) and provides this information to an application program stored within one of the memory components 904 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 932 are contemplated.

The accelerometer 934 is configured to measure proper acceleration. In some configurations, output from the accelerometer 934 is used by an application program as an input mechanism to control some functionality of the application program. For example, the application program may be a video game in which a character, a portion thereof, or an object is moved or otherwise manipulated in response to input received via the accelerometer 934. In some configurations, output from the accelerometer 934 is provided to an application program for use in switching between landscape and portrait modes, calculating coordinate acceleration, or detecting a fall. Other uses of the accelerometer 934 are contemplated.

The gyroscope 936 is configured to measure and maintain orientation. In some configurations, output from the gyroscope 936 is used by an application program as an input mechanism to control some functionality of the application program. For example, the gyroscope 936 can be used for accurate recognition of movement within a 3D environment of a video game application or some other application. In some configurations, an application program utilizes output from the gyroscope 936 and the accelerometer 934 to enhance control of some functionality of the application program. Other uses of the gyroscope 936 are contemplated.

The GPS sensor 938 is configured to receive signals from GPS satellites for use in calculating a location. The location calculated by the GPS sensor 938 may be used by any application program that requires or benefits from location information. For example, the location calculated by the GPS sensor 938 may be used with a navigation application program to provide directions from the location to a destination or directions from the destination to the location. Moreover, the GPS sensor 938 may be used to provide location information to an external location-based service, such as E911 service. The GPS sensor 938 may obtain location information generated via WI-FI, WIMAX, and/or cellular triangulation techniques utilizing one or more of the network connectivity components 906 to aid the GPS sensor 938 in obtaining a location fix. The GPS sensor 938 may also be used in Assisted GPS (“A-GPS”) systems.

The I/O components 910 include a display 940, a touchscreen 942, a data I/O interface component (“data I/O”) 944, an audio I/O interface component (“audio I/O”) 946, a video I/O interface component (“video I/O”) 948, and a camera 950. In some configurations, the display 940 and the touchscreen 942 are combined. In some configurations two or more of the data I/O component 944, the audio I/O component 946, and the video I/O component 948 are combined. The I/O components 910 may include discrete processors configured to support the various interface described below, or may include processing functionality built-in to the processor 902.

The display 940 is an output device configured to present information in a visual form. In particular, the display 940 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 940 is a liquid crystal display (“LCD”) utilizing any active or passive matrix technology and any backlighting technology (if used). In some configurations, the display 940 is an organic light emitting diode (“OLED”) display. Other display types are contemplated.

The touchscreen 942, also referred to herein as a “touch-enabled screen,” is an input device configured to detect the presence and location of a touch. The touchscreen 942 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 942 is incorporated on top of the display 940 as a transparent layer to enable a user to use one or more touches to interact with objects or other information presented on the display 940. In other configurations, the touchscreen 942 is a touch pad incorporated on a surface of the computing device that does not include the display 940. For example, the computing device may have a touchscreen incorporated on top of the display 940 and a touch pad on a surface opposite the display 940.

In some configurations, the touchscreen 942 is a single-touch touchscreen. In other configurations, the touchscreen 942 is a multi-touch touchscreen. In some configurations, the touchscreen 942 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 942. As such, a developer may create gestures that are specific to a particular application program.

In some configurations, the touchscreen 942 supports a tap gesture in which a user taps the touchscreen 942 once on an item presented on the display 940. The tap gesture may be used for various reasons including, but not limited to, opening or launching whatever the user taps. In some configurations, the touchscreen 942 supports a double tap gesture in which a user taps the touchscreen 942 twice on an item presented on the display 940. The double tap gesture may be used for various reasons including, but not limited to, zooming in or zooming out in stages. In some configurations, the touchscreen 942 supports a tap and hold gesture in which a user taps the touchscreen 942 and maintains contact for at least a pre-defined time. The tap and hold gesture may be used for various reasons including, but not limited to, opening a context-specific menu.

In some configurations, the touchscreen 942 supports a pan gesture in which a user places a finger on the touchscreen 942 and maintains contact with the touchscreen 942 while moving the finger on the touchscreen 942. The pan gesture may be used for various reasons including, but not limited to, moving through screens, images, or menus at a controlled rate. Multiple finger pan gestures are also contemplated. In some configurations, the touchscreen 942 supports a flick gesture in which a user swipes a finger in the direction the user wants the screen to move. The flick gesture may be used for various reasons including, but not limited to, scrolling horizontally or vertically through menus or pages. In some configurations, the touchscreen 942 supports a pinch and stretch gesture in which a user makes a pinching motion with two fingers (e.g., thumb and forefinger) on the touchscreen 942 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 942. As such, the above gestures should be understood as being illustrative and should not be construed as being limiting in any way.

The data I/O interface component 944 is configured to facilitate input of data to the computing device and output of data from the computing device. In some configurations, the data I/O interface component 944 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 946 is configured to provide audio input and/or output capabilities to the computing device. In some configurations, the audio I/O interface component 946 includes a microphone configured to collect audio signals. In some configurations, the audio I/O interface component 946 includes a headphone jack configured to provide connectivity for headphones or other external speakers. In some configurations, the audio I/O interface component 946 includes a speaker for the output of audio signals. In some configurations, the audio I/O interface component 946 includes an optical audio cable out.

The video I/O interface component 948 is configured to provide video input and/or output capabilities to the computing device. In some configurations, the video I/O interface component 948 includes a video connector configured to receive video as input from another device (e.g., a video media player such as a DVD or BLURAY player) or send video as output to another device (e.g., a monitor, a television, or some other external display). In some configurations, the video I/O interface component 948 includes a High-Definition Multimedia Interface (“HDMI”), mini-HDMI, micro-HDMI, DisplayPort, or proprietary connector to input/output video content. In some configurations, the video I/O interface component 948 or portions thereof is combined with the audio I/O interface component 946 or portions thereof.

The camera 950 can be configured to capture still images and/or video. The camera 950 may utilize a charge coupled device (“CCD”) or a complementary metal oxide semiconductor (“CMOS”) image sensor to capture images. In some configurations, the camera 950 includes a flash to aid in taking pictures in low-light environments. Settings for the camera 950 may be implemented as hardware or software buttons. The camera can also include any type of sensor using any type of modality, e.g., a first modality may be under infrared, a second modality may be under a different spectrum, e.g., visible light, laser, etc. The camera may also include a time-of-flight sensor which can operate using any suitable medium, e.g., sonar, radar, etc. the camera can also be in the form of a lidar sensor for capturing images and distances device and will object in a surrounding environment.

Although not illustrated, one or more hardware buttons may also be included in the computing device architecture 900. The hardware buttons may be used for controlling some operational aspect of the computing device. The hardware buttons may be dedicated buttons or multi-use buttons. The hardware buttons may be mechanical or sensor-based.

The illustrated power components 914 include one or more batteries 952, which can be connected to a battery gauge 954. The batteries 952 may be rechargeable or disposable. Rechargeable battery types include, but are not limited to, lithium polymer, lithium ion, nickel cadmium, and nickel metal hydride. Each of the batteries 952 may be made of one or more cells.

The battery gauge 954 can be configured to measure battery parameters such as current, voltage, and temperature. In some configurations, the battery gauge 954 is configured to measure the effect of a battery's discharge rate, temperature, age and other factors to predict remaining life within a certain percentage of error. In some configurations, the battery gauge 954 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 912 may also include a power connector, which may be combined with one or more of the aforementioned I/O components 910. The power components 912 may interface with an external power system or charging equipment via an I/O component.

### Example Clauses

Clause A. A computer-implemented method for providing intelligent recommendations of specific content 127 based on selections of curated response candidates 123, the method for execution on a system, the method comprising: accessing one or more datastores 119 comprising a plurality of curated response candidates 123, wherein individual curated response candidates 122 correspond to individual characteristics 124; selecting a category 121 that is associated with a set of curated response candidates 127 of a collection of curated response candidates 123; causing a communication of the set of curated response candidates 127 to one or more computing devices 11; receiving input data identifying a selected response 128 from the one or more computing devices 11, wherein the selected response 128 includes at least one curated response candidate 127 from the set of curated response candidates 127; selecting specific characteristics 129 that correspond to the selected response 128, wherein the selection of the of the specific characteristics 129 is based on an analysis of the one or more datastores 119 that associates individual curated response candidates 123 that correspond to the individual characteristics 124; selecting specific content 130 from a collection of content 126, wherein the specific content 130 is selected based on an analysis of the one or more datastores 119 that associates individual pieces of content with corresponding content characteristics 125, wherein the specific content 130 includes an individual piece of content from the collection of content 126 based on an identification of the individual piece of content having at least one content characteristic 125 that has a threshold match with the specific characteristics 129 that is identified in the selected response 128 of the set of curated response candidates 127; and generating output data identifying the specific content 130 having the specific characteristics 129 that are identified in the selected response 128 from the set of curated response candidates 127.
Clause B. The computer-implemented method of Clause A, wherein the method further comprises: selecting one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.
Clause C. The computer-implemented method of Clauses A and B, wherein the method further comprises: selecting one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.
Clause D. The computer-implemented method of Clauses A through C, wherein the category is selected based on an analysis of attributes of the item that is a subject of a review form comprising the set of curated response candidates, wherein an attribute of the item has a threshold match with one or more keywords associated with the category.
Clause E. The computer-implemented method of Clauses A through D, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.
Clause F. The computer-implemented method of Clauses A through E, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.
Clause G. The computer-implemented method of Clauses A through F, wherein the category is selected based on an analysis of attributes of a profile of a person associated with an item that is a subject of a review form comprising the set of curated response candidates, wherein an attribute of the profile has a threshold match with one or more keywords associated with the category.
Clause H. A computing device 900 for providing intelligent recommendations of specific content 127 based on selections of curated response candidates 123, comprising: one or more processing units 902; and a computer-readable storage medium 904 having encoded thereon computer-executable instructions to cause the one or more processing units 902 to: access one or more datastores 119 comprising a plurality of curated response candidates 123, wherein individual curated response candidates 122 correspond to individual characteristics 124; select a category 121 that is associated with a set of curated response candidates 127 of a collection of curated response candidates 123; cause a communication of the set of curated response candidates 127 to one or more computing devices 11; receive input data identifying a selected response 128 from the one or more computing devices 11, wherein the selected response 128 includes at least one curated response candidate 127 from the set of curated response candidates 127; select specific characteristics 129 that correspond to the selected response 128, wherein the selection of the of the specific characteristics 129 is based on an analysis of the one or more datastores 119 that associates individual curated response candidates 123 that correspond to the individual characteristics 124; select specific content 130 from a collection of content 126, wherein the specific content 130 is selected based on an analysis of the one or more datastores 119 that associates individual pieces of content with corresponding content characteristics 125, wherein the specific content 130 includes an individual piece of content from the collection of content 126 based on an identification of the individual piece of content having at least one content characteristic 125 that has a threshold match with the specific characteristics 129 that is identified in the selected response 128 of the set of curated response candidates 127; and generate output data identifying the specific content 130 having the specific characteristics 129 that are identified in the selected response 128 from the set of curated response candidates 127.
Clause I. The computing device of Clause H, wherein the instructions further cause the one or more processing units to: select one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.
Clause J. The computing device of Clauses H and I, wherein the instructions further cause the one or more processing units to: select one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.
Clause K. The computing device of Clauses H through J, wherein the category is selected based on an analysis of attributes of the item that is a subject of a review form comprising the set of curated response candidates, wherein an attribute of the item has a threshold match with one or more keywords associated with the category.
Clause L. The computing device of Clauses H through K, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.
Clause M. The computing device of Clauses H through L, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.
Clause N. The computing device of Clauses H through M, wherein the category is selected based on an analysis of attributes of a profile of a person associated with an item that is a subject of a review form comprising the set of curated response candidates, wherein an attribute of the profile has a threshold match with one or more keywords associated with the category.
Clause O. A computer-readable storage medium 904 having encoded thereon computer-executable instructions to cause one or more processing units 902 of a computing device 900 to: access one or more datastores 119 comprising a plurality of curated response candidates 123, wherein individual curated response candidates 122 correspond to individual characteristics 124; select a category 121 that is associated with a set of curated response candidates 127 of a collection of curated response candidates 123; cause a communication of the set of curated response candidates 127 to one or more computing devices 11; receive input data identifying a selected response 128 from the one or more computing devices 11, wherein the selected response 128 includes at least one curated response candidate 127 from the set of curated response candidates 127; select specific characteristics 129 that correspond to the selected response 128, wherein the selection of the of the specific characteristics 129 is based on an analysis of the one or more datastores 119 that associates individual curated response candidates 123 that correspond to the individual characteristics 124; select specific content 130 from a collection of content 126, wherein the specific content 130 is selected based on an analysis of the one or more datastores 119 that associates individual pieces of content with corresponding content characteristics 125, wherein the specific content 130 includes an individual piece of content from the collection of content 126 based on an identification of the individual piece of content having at least one content characteristic 125 that has a threshold match with the specific characteristics 129 that is identified in the selected response 128 of the set of curated response candidates 127; and generate output data identifying the specific content 130 having the specific characteristics 129 that are identified in the selected response 128 from the set of curated response candidates 127.
Clause P. The computer-readable storage medium of Clause O, wherein the instructions further cause the one or more processing units to: select one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.
Clause Q. The computer-readable storage medium of Clauses O and P, wherein the instructions further cause the one or more processing units to: select one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.
Clause R. The computer-readable storage medium of Clauses O through Q, wherein the category is selected based on an analysis of attributes of the item that is a subject of a review form comprising the set of curated response candidates, wherein an attribute of the item has a threshold match with one or more keywords associated with the category.
Clause S. The computer-readable storage medium of Clauses O through R, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.
Clause T. The computer-readable storage medium of Clauses O through S, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method for providing intelligent recommendations of specific content based on selections of curated response candidates, the method for execution on a system, the method comprising:
accessing one or more datastores comprising a plurality of curated response candidates, wherein individual curated response candidates correspond to individual characteristics;
selecting a category that is associated with a set of curated response candidates of a collection of curated response candidates;
causing a communication of the set of curated response candidates to one or more computing devices;
receiving input data identifying a selected response from the one or more computing devices, wherein the selected response includes at least one curated response candidate from the set of curated response candidates;
selecting specific characteristics that correspond to the selected response, wherein the selection of the of the specific characteristics is based on an analysis of the one or more datastores that associates individual curated response candidates that correspond to the individual characteristics;
selecting specific content from a collection of content, wherein the specific content is selected based on an analysis of the one or more datastores that associates individual pieces of content with corresponding content characteristics, wherein the specific content includes an individual piece of content from the collection of content based on an identification of the individual piece of content having at least one content characteristic that has a threshold match with the specific characteristics that is identified in the selected response of the set of curated response candidates; and
generating output data identifying the specific content having the specific characteristics that are identified in the selected response from the set of curated response candidates.

2. The computer-implemented method of claim 1, wherein the method further comprises: selecting one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.

3. The computer-implemented method of claim 1, wherein the method further comprises: selecting one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.

4. The computer-implemented method of claim 1, wherein the category is selected based on an analysis of attributes of the item that is a subject of a review form comprising the set of curated response candidates, wherein an attribute of the item has a threshold match with one or more keywords associated with the category.

5. The computer-implemented method of claim 1, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.

6. The computer-implemented method of claim 1, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.

7. The computer-implemented method of claim 1, wherein the category is selected based on an analysis of attributes of a profile of a person associated with an item that is a subject of a review form comprising the set of curated response candidates, wherein an attribute of the profile has a threshold match with one or more keywords associated with the category.

8. A computing device for providing intelligent recommendations of specific content based on selections of curated response candidates, comprising:
one or more processing units; and
a computer-readable storage medium having encoded thereon computer-executable instructions to cause the one or more processing units to:
access one or more datastores comprising a plurality of curated response candidates, wherein individual curated response candidates correspond to individual characteristics;
select a category that is associated with a set of curated response candidates of a collection of curated response candidates;
cause a communication of the set of curated response candidates to one or more computing devices;
receive input data identifying a selected response from the one or more computing devices, wherein the selected response includes at least one curated response candidate from the set of curated response candidates;
select specific characteristics that correspond to the selected response, wherein the selection of the of the specific characteristics is based on an analysis of the one or more datastores that associates individual curated response candidates that correspond to the individual characteristics;
select specific content from a collection of content, wherein the specific content is selected based on an analysis of the one or more datastores that associates individual pieces of content with corresponding content characteristics, wherein the specific content includes an individual piece of content from the collection of content based on an identification of the individual piece of content having at least one content characteristic that has a threshold match with the specific characteristics that is identified in the selected response of the set of curated response candidates; and
generate output data identifying the specific content having the specific characteristics that are identified in the selected response from the set of curated response candidates.

9. The computing device of claim 8, wherein the instructions further cause the one or more processing units to: select one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.

10. The computing device of claim 8, wherein the instructions further cause the one or more processing units to: select one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.

11. The computing device of claim 8, wherein the category is selected based on an analysis of attributes of the item that is a subject of a review form comprising the set of curated response candidates, wherein an attribute of the item has a threshold match with one or more keywords associated with the category.

12. The computing device of claim 8, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.

13. The computing device of claim 8, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.

14. The computing device of claim 8, wherein the category is selected based on an analysis of attributes of a profile of a person associated with an item that is a subject of a review form comprising the set of curated response candidates, wherein an attribute of the profile has a threshold match with one or more keywords associated with the category.

15. A computer-readable storage medium having encoded thereon computer-executable instructions to cause one or more processing units of a computing device to:
access one or more datastores comprising a plurality of curated response candidates, wherein individual curated response candidates correspond to individual characteristics;
select a category that is associated with a set of curated response candidates of a collection of curated response candidates;
cause a communication of the set of curated response candidates to one or more computing devices;
receive input data identifying a selected response from the one or more computing devices, wherein the selected response includes at least one curated response candidate from the set of curated response candidates;
select specific characteristics that correspond to the selected response, wherein the selection of the of the specific characteristics is based on an analysis of the one or more datastores that associates individual curated response candidates that correspond to the individual characteristics;
select specific content from a collection of content, wherein the specific content is selected based on an analysis of the one or more datastores that associates individual pieces of content with corresponding content characteristics, wherein the specific content includes an individual piece of content from the collection of content based on an identification of the individual piece of content having at least one content characteristic that has a threshold match with the specific characteristics that is identified in the selected response of the set of curated response candidates; and
generate output data identifying the specific content having the specific characteristics that are identified in the selected response from the set of curated response candidates.

16. The computer-readable storage medium of claim 15, wherein the instructions further cause the one or more processing units to: select one or more questions from a collection of questions for inclusion in a review form, wherein the selection of the one or more questions is based on analysis of the one or more datastores associating individual questions with individual categories, wherein the one or more questions selected for the review form is associated with the category associated with the set of curated response candidates, wherein the communication of the set of curated response candidates to the one or more computing devices includes communicating the set of curated response candidates with the one or more questions in the review form.

17. The computer-readable storage medium of claim 15, wherein the instructions further cause the one or more processing units to: select one or more questions from a collection of questions for inclusion in a review form, wherein the selection of the one or more questions is based on analysis of the one or more datastores associating individual questions with the set of curated response candidates, wherein the communication of the set of curated response candidates to the one or more computing devices includes communicating the set of curated response candidates with the one or more questions in the review form.

18. The computer-readable storage medium of claim 15, wherein the category is selected based on an analysis of attributes of the item that is a subject of a review form comprising the set of curated response candidates, wherein an attribute of the item has a threshold match with one or more keywords associated with the category.

19. The computer-readable storage medium of claim 15, wherein the category is selected based on an analysis of a number of reviews provided by a person associated with an item that is a subject of a review form comprising the set of curated response candidates, wherein an attribute of the reviews provided by the person has a threshold match with one or more keywords associated with the category.

20. The computer-readable storage medium of claim 15, wherein the category is selected based on an analysis of a number of purchases provided by a person associated with an item that is a subject of a review form comprising the set of curated response candidates, wherein an attribute of the purchases provided by the person has a threshold match with one or more keywords associated with the category.
